(19) United States
(12) Patent Application Publication
(10) Pub. No.: US 2025/0086941 A1
(43) Pub. Date: Mar. 13, 2025

(54) PROCESSING OF IMAGE DATA WITH A MACHINE-LEARNED FOUNDATION MODEL

(71) Applicant: Carl Zeiss Microscopy GmbH, Jena (DE)

(72) Inventors: Manuel AMTHOR, Jena (DE); Daniel HAASE, Jena (DE)

(21) Appl. No.: 18/821,806

(22) Filed: Aug. 30, 2024

(30) Foreign Application Priority Data
Sep. 13, 2023 (DE) 10 2023 124 788.3

(51) Int. Cl. G06V 10/70; G06V 10/778

(52) U.S. Cl. CPC G06V 10/768; G06V 10/7788

(57) ABSTRACT

A domain-specific machine-learned model is used to generate context information for a generic machine-learned foundation model. Its output may then be used in turn to retrain the domain-specific machine-learned model.

### TECHNICAL FIELD

Various disclosed examples relate to techniques for processing image data. Various examples relate to techniques for predicting image features, for example in particular the localization of specific structures in images. Various examples relate to techniques for generating training data for a machine-learned model based on the processing of image data in order to derive such a prediction.

### BACKGROUND

The automated processing of image data plays an important role in microscopy in various fields of application (domains). By way of example, it is possible to assist the user in positioning the sample in the field of view of the microscope. For this purpose, an overview image is evaluated by way of an algorithm. Data evaluation close to the recording is also possible. Further aspects relate to the instance segmentation of cells, for example for determining a degree of confluence or for automating a cell count. Machine-learning methods, in particular machine learning/deep learning models such as deep neural networks etc., are used in all of these domains.

Training such models requires annotated training data, that is to say input image data and associated ground truths (the annotations). The machine-learned model then learns to generate outputs corresponding to the annotations seen in the training data for new and unseen images (inference phase).

Generating annotations is in this case a largely manual process and often represents the bottleneck when creating new models. Due to the large number of domains in which machine-learned models are used, this effort increases with each new task to be solved.

### BRIEF SUMMARY

A description is given below of techniques as to how a first machine-learned model with a low degree of complexity is able to provide context information for a second machine-learned model with a higher degree of complexity.

The first machine-learned model (hereinafter simply first model) may be referred to as domain-specific model or dedicated model, since at least a certain degree of training has been carried out for a domain-specific application. Due to the limited complexity of the first model, it is not possible, or is possible only to a certain extent, to use a domain-specific model for inference in another domain as well. The first machine-learned model or the domain-specific model will be referred to below simply as first model.

The second machine-learned model (hereinafter simply second model) may be referred to for example as foundation model or basic model, which is generic enough to solve tasks in different domains. This is made possible by the relatively high degree of complexity of the foundation model. This foundation model will be referred to below simply as second model.

The techniques disclosed herein may be applied to the processing of different image data. Microscope image data may be processed, for example. However, volume image data may also be processed. Medical image data or biological image data may be processed. By way of example, a Z-stack of multiple images may be processed. The image data may be microscopic images, but also macroscopic (overview) images. There are also no restrictions with regard to the recording system (wide field, LSM, Lattice Lightsheet, etc.), the contrast type (brightfield, DIC, fluorescence staining), etc. Magnetic resonance images or computed tomography image data may be processed.

In the course of such processing, the first model is first applied to the image data in order to process the image data. This gives a first prediction for image features in the image data.

The first prediction may for example concern localization of structures in the image data. Localization information may be provided. However, other predictions would also be possible. For example, a number of structures could be counted (for example cell count). Localization information may be provided for example in the form of a center point marker of a corresponding structure, a center of gravity marker of a corresponding structure, by way of a bounding box or as segmentation.

As an alternative or in addition to a localization of structures in the image data, the first prediction and/or the second prediction may comprise a classification of one or more structures in the image data.

A global parameter could be determined (for example cell degree of confluence or tumor yes/no).

Context information for the second model is then determined based on the first prediction. The context information configures the second model; the context information may therefore also be referred to as a prompt or configuration command.

In one example, the first prediction of the first model will be adopted directly as context information. The context information may also be derived from the first prediction, for example by determining a coding and/or by modifying the first prediction. A user input may be taken into account here. The user is able to intervene interactively in the method in this way by correcting or refining the context information.

In so doing, the user may be presented selectively with part of the first prediction by way of a user output, such that the user modifies this part of the first prediction. This part of the first prediction may be determined by way of an active learning process. By way of example, a certain part of the first prediction may be selected based on confidence or a trade-off between exploration and use in the input data space. This makes it possible to achieve a particularly steep learning curve.

Based on the context information, the second model may then provide a second prediction for the image features by virtue of the second machine-learned model processing the image data.

The second prediction may in this case correspond to the first prediction. For example, if the first prediction comprises a first localization of structures in the image data, then the second prediction also comprises a second localization of these structures in their image data. This thus means that the first prediction and the second prediction solve the same task (for example localizing specific structures, such as cells for example). Nevertheless, the first prediction may differ from the second prediction in terms of quantity and/or quality.

The second prediction may be more accurate, more complete, higher-resolution or more comprehensive than the first prediction. By way of example, the first prediction may localize specific structures (for example cells) in the image data only incompletely and/or with relatively low accuracy (false-positive or false-negative) and/or with low resolution (for example only center point localization). The second prediction may then localize all cells with high accuracy and high resolution (for example instantial segmentation with a segmentation mask).

The second model thus makes it possible—generally speaking—to improve the quality of the prediction. This may then be exploited in various ways. By way of example, training data may be generated; the training data contain a ground truth that may correspond to the second prediction or is determined based thereon. Other applications for the second prediction include for example determining a model confidence or model selection.

The features set out above and features that are described hereinbelow may be used not only in the corresponding combinations explicitly set out, but also in further combinations or in isolation, without departing from the scope of protection of the present invention.

### BRIEF DESCRIPTION OF THE FIGURES

FIG. 1 schematically illustrates a data processing pipeline for processing image data using two sequential models, a first model and a second model, according to various examples.

FIG. 2 schematically shows a data processing device according to various examples.

FIG. 3 is a flowchart of one exemplary method.

FIG. 4 schematically illustrates a deployment scenario for a foundation model according to various examples.

### DETAILED DESCRIPTION

The properties, features and advantages of this invention described above and the way in which they are achieved will become clearer and more clearly understood in association with the following description of the exemplary embodiments which are explained in greater detail in association with the drawings.

The present invention is explained in greater detail below on the basis of preferred embodiments with reference to the drawings. In the figures, identical reference signs denote identical or similar elements. The figures are schematic representations of various embodiments of the invention. Elements illustrated in the figures are not necessarily illustrated as true to scale. Rather, the various elements illustrated in the figures are rendered in such a way that their function and general purpose become comprehensible to a person skilled in the art. Connections and couplings between functional units and elements illustrated in the figures may also be implemented as an indirect connection or coupling. A connection or coupling may be implemented in a wired or wireless manner. Functional units may be implemented as hardware, software or a combination of hardware and software.

A description is given below of techniques for processing image data, in particular microscope image data. The processing is carried out by way of machine-learned models. Artificial deep neural networks may in particular be used. Convolutional layers may be used.

A convolutional layer in a convolutional neural network (CNN) uses one or more filters to slide over an input image or an input map. These filters, often referred to as “kernels,” are small matrices that are able to recognize certain features or patterns in the image. In each step, the filter is multiplied pointwise by a local region of the image and summed to create a single value in an output map. This process is repeated for the entire image, thereby creating a “feature map”. Convolutional layers allow a CNN to learn spatial hierarchies of features in the data. The kernels and the concatenations between the layers, as well as the number of layers, are parameters; the more parameters a CNN (or more generally a model) has, the more complex it is.

By way of example, a CNN with a U-net architecture may be used to process image data in the various examples described herein. Such a CNN with a U-net architecture in particular allows domain-specific processing of the image data. The architecture of the U-net is described in detail in: Ronneberger, Olaf, Philipp Fischer, and Thomas Brox. “U-net: Convolutional networks for biomedical image segmentation.” Medical Image Computing and Computer-Assisted Intervention-MICCAI 2015: 18th International Conference, Munich, Germany, Oct. 5-9, 2015, Proceedings, Part III 18. Springer International Publishing, 2015. In short, the U-net is an architecture for segmenting image data, characterized by its characteristic “U” shape. It consists of a contractive path (encoder) that extracts information from the input image data, and an expansive path (decoder) that uses this information to create a detailed segmentation map. While information loss occurs in the contractive path due to max pooling layers, the expansive path uses up-sampling operations. Skip connections between the corresponding layers of the encoder and the decoder ensure that the spatial information is preserved.

Another architecture able to be used is the transformer architecture. A transformer network is based on self-attention mechanisms that correlate input sequences in order to weight context information. The main components are multi-head self-attention and feedforward neurons. In self-attention, weightings are computed for each element of the sequence depending on how closely said element is linked to other elements. Multi-head attention allows the network to record different types of relationships at the same time. Finally, the weighted outputs pass through a feedforward layer before being forwarded to the next block in the network.

In the various examples, two machine-learned models are characteristically connected in sequence. In this case, a first machine-learned model (hereinafter simply first model) is first used to process image data. This gives a first prediction for image features in the image data. The image data are then also processed in a second machine-learned model (hereinafter simply second model), with the second model generating a second prediction for the image features.

The first and second models are concatenated using context information. The context information for the second model is determined based on the first prediction of the first model.

The context information is used here to control a specific type of information processing or response generation in the second model. While the input is the primary data element (for example an image) to be analyzed or interpreted by way of the second model, the context information provides a guideline as to how the second model should consider or respond to the input. By way of example, an input could be an image of an animal, and the context information could be: “Determine the color of the animal”. This context information instructs the second model to focus on one particular aspect of the image, namely the color of the animal, rather than merely providing a general description or categorization of the image.

The context information may thus specify the domain in which the second model is to operate.

In order for the second model basically to be able to operate in different domains, the second model has a high degree of complexity. The second model may have a higher degree of complexity than the first model. By way of example, the number of parameters in the second model may be significantly greater than the number of parameters in the first model. By way of example, the number of parameters in the second model could be greater by at least a factor of E3 or by at least a factor of E6 or more than in the first model.

Due to the smaller number of parameters of the first model, it is comparatively poor in terms of generalization, that is to say difficult to use to solve tasks other than the specific task for which it was trained.

The first model may be a domain-specific model. This means that the first model may provide the first prediction for a specific application case. By way of example, a specific application case could be: Localizing cells in a microscope image acquired by way of phase contrast microscopy. Using the context information, the second model may then be configured to provide the second prediction in the domain of the first model as well.

The second model may be a generic model. This means that the second model is not domain-specific. The second model may be used for various application cases due to its high degree of complexity. The second model may in particular be a foundation model.

A foundation model is trained on large amounts of data and forms a basis for more specific models used in specific fields of application. Foundation models are general enough to handle a wide variety of tasks. Foundation models often have a transformer architecture. The transformer architecture may have an encoder and a decoder. The hidden layers have one or more “self-attention layers” and one or more feedforward layers. The number of layers and the size of each layer (that is to say the number of “neurons” or nodes in each layer) are model parameters that are able to be adjusted during training. Foundation models are often task-agnostic or may at least be applied to a large number of different tasks. In addition to the input, the foundation model is for this purpose also provided with context information that describes the task to be solved. By way of example, the foundation model “SAM” described in Kirillov, Alexander, et al. “Segment anything.” ArXiv Preprint arXiv:2304.02643 (2023) requires point annotations that (i) show the SAM foundation model which objects in the image should be segmented and (ii) correct potentially incorrect segmentation regions. Foundation models are in particular not domain-specific. Foundation models have been applied in particular to segmentation tasks. See Kirillov, Alexander, et al. “Segment anything.” arXiv preprint arXiv:2304.02643 (2023). Different structures are able to be segmented flexibly here. The input image data may also vary. For example, Ma, Jun, and Bo Wang. “Towards foundation models of biological image segmentation.” Nature Methods 20.7 (2023): 953-955 describes how foundation models are able to solve various segmentation tasks with regard to the segmentation of structures in microscopy image data. In summary, the foundation model is thus an extremely complex model that often generally cannot work in real time due to its high inference time. It has been trained on large amounts of data covering a wide variety of domains. It has thereby learned the ability to recognize what is generally considered to be an object or region, and is able to generalize well. In order to know exactly what is to be segmented, detected or recognized in some other way, this model also requires, in addition to an input image, context information in the form of a prompt.

Various examples are based on the finding that using a foundation model directly to solve a particular task may be problematic. This is due to the fact that such foundation models have a large number of parameters, and the inference by way of such foundation models is thus particularly computationally intensive. Such foundation models are thus often not suitable for rapid use in the field, for example on a computer of a microscope. Because the foundation models are not domain-specific but rather generic, it may be the case that the quality of a prediction of a foundation model is lower than the quality of a prediction of a domain-specific model. In particular, the quality of the prediction of the foundation model may correlate with the quality of the provided context information (prompt).

A description is given below of techniques as to how a foundation model is able to be used efficiently in conjunction with a domain-specific model in order to enable the processing of image data. More generally, a description is given below of techniques as to how a first model (the domain-specific model) with a low degree of complexity and a second model (for example the foundation model) with a high degree of complexity are able to interact to enable the processing of image data.

The first model may be pretrained to a certain extent. The first model may be trained on a relatively rudimentary basis. This means that the results of the first prediction of the first model may be relatively inaccurate or may be incomplete. By way of example, it would be conceivable for the first (domain-specific) model to provide only an incomplete domain-specific prediction. If for example cell instances are localized, then it would be conceivable for the first model not to correctly identify every cell instance. By way of example, the first model might not make a distinction between “cell” and “non-cell” for each pixel in a microscope image, but rather only provide a certain fraction of all cells with a point annotation (for example geometric center point).

Various examples are based on the finding that it may be possible, despite the limited quality of the first prediction of the first model, to determine context information for a second model, in particular for a foundation model, based on the first prediction. The second model then makes it possible to generate the second prediction, which has a higher quality than the first prediction.

By way of example, a second localization generated by the second model could have a higher accuracy, that is to say contain fewer false-positive results, etc., than a first localization provided by the first model. For example, it would be conceivable for the second localization to provide a more complete localization, for example to detect all instances of a structure (for example a cell), or at least a much larger fraction than the first localization. It would also be conceivable for the second localization to have a greater degree of detail than the first localization: by way of example, the first localization could include only a point localization, while the second localization provides a segmentation. The segmentation is used not only to localize a center point or center of gravity of a particular structure, but rather to indicate the extent and shape of the corresponding structure.

In the various examples, the localization could be provided as point localization or bounding-box localization or segmentation. A semantic segmentation could thus be provided. Semantic segmentation aims to classify each pixel in an image according to its associated object category without distinguishing between individual instances of the same category. Instance segmentation—another example—assigns unique identifiers if they belong to the same category. One application example is the identification and separation of individual cells in multiplex immunofluorescence images, such that each cell is able to be analyzed separately. Panoptic segmentation combines elements of semantic segmentation and instance segmentation with the aim of identifying the semantic category of each pixel and assigning a unique identifier to each object of the same class.

The second prediction then enables different applications. By way of example, the first machine-learned model could be retrained based on the second prediction. The second model may thus be used to generate ground truths for training data with relatively little user effort, these ground truths then being used to improve the first model.

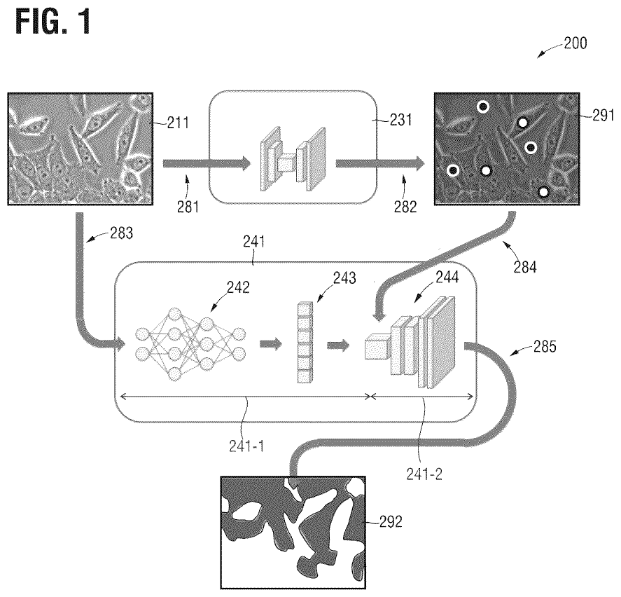

FIG. 1 schematically illustrates a data processing pipeline 200. In the data processing pipeline 200, point localizations with a class assignment (combined localization and classification prediction) are determined by way of a first model 231 (domain-specific model) and transferred, as context information, to a second model 241 (foundation model). The foundation model 241 comprises an encoder 242 that generates latent representations 243, and a decoder 244. The foundation model 241 delivers result masks of a semantic segmentation. This is described in detail below.

Image data 211 are transferred to a domain-specific machine-learned model 231 (at 281). The domain-specific model 231 may be implemented in accordance with previously known architectures. The example in FIG. 1 indicates a deep neural convolutional network, for example a U-net. This gives a first prediction 212 for image features in the image data (at 282). At 284, this first prediction 212 is transferred to the generic machine-learned foundation model 241 as context information. The foundation model 241 processes—at 283—the image data 281 as input. The foundation model 241 provides, at 285, a second prediction 212 for image features.

The context information is transferred, at 284, to the foundation model 241: the context information is not transferred to the input layer of the foundation model 241 (where the image data 211 are transferred). As a general rule, the context information from the first model may be transferred to a different input of the second model than the image data. By way of example, the image data may pass through an encoder, but not the context information. In the case of a (vision) transformer architecture of the second model—as described by Kirillov, Alexander et al. —the reference segmentation is converted into an embedding and is supplied to the foundation model as a token downstream of the decoder; such a variant is also conceivable in the present case. In the case of an implementation of the foundation model as a CNN, the context information may flow into one of the hidden layers (that is to say between input layer and output layer) as a continuous value or likewise as an embedding.

In the example in FIG. 1, the predictions 291, 292 relate to the localization of structures of multiple classes, specifically cells vs. background in a phase contrast microscope image. A classification thus also takes place in addition to a localization.

The prediction 291 of the domain-specific model 231 is an incomplete point localization (black circle with a white border: “background”; white circle with a black border: “cell”). Not all cells are recognized.

The prediction 292 of the foundation model is a complete semantic segmentation (dark: “background”; bright: “cell”).

Generally, the techniques described here are not limited to such predictions for the localization of cells. In general, tasks in a wide spectrum could be solved, for example: cell detection, confluence estimation, cell instance segmentation (specific cell lines only), tissue (region) segmentation, particle detection, organelle localization, segmentation of overview images, and many more. Applications in completely different technological fields are in particular also conceivable, including for example for bacteria, PCB, gas & oil, neuro, metrology, material science, transcriptomics, etc.

In general, it would be conceivable for the accuracy of the prediction 291 of the domain-specific model to be lower than the accuracy of the prediction 292 of the generic foundation model. Accuracy may here for example denote the number of incorrect localizations (offset from cell center point) or the incorrect assignment of a region to a cell (background is actually imaged). By way of example, in the specific example in FIG. 1, a certain pixel could be classified incorrectly as “background” because a cell is actually located there.

By way of example, it would also be conceivable for the prediction 291 of the domain-specific model 231 to provide the localization with a lower image space density than the prediction 292 of the foundation model 241. By way of example, the prediction 291 localizes the cells only for a few pixels, while the prediction 292 classifies all pixels of the microscope image 211 into “cell” and “background”.

By way of example, it would be conceivable for the prediction 291 of the domain-specific model 231 to provide a lower degree of detail than the prediction 292 of the generic foundation model 241. For example, the degree of detail may concern a degree of detail with which the localization is provided. For instance, the localization of the prediction 291 is a point localization, and thus has a low degree of detail; whereas the localization of the prediction 292 is an instance segmentation and thus has a high degree of detail.

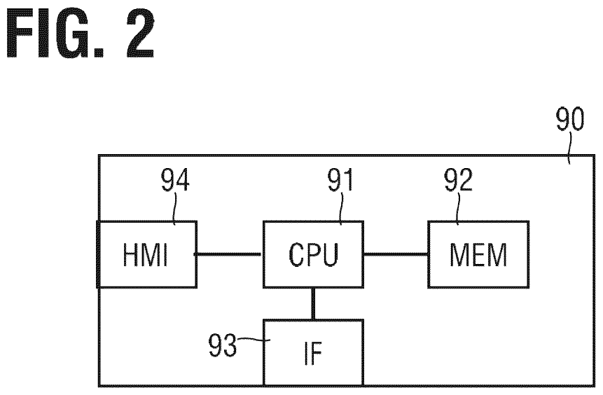

FIG. 2 schematically shows a data processing device 90. The data processing device 90 comprises a processor 91 and a memory 92 as also a communication interface 93 and a human-machine interface 94.

A user input may be received via the human-machine interface 94 and processed by the processor 91. By way of example, images or information may be output to a user via the human-machine interface 94. The human-machine interface 94 may comprise one or more of the following elements: screen; mouse; keyboard.

Image data may be received via the communication interface 93. By way of example, image data may be received from an image data memory or an image data acquisition unit such as a microscope. It is also conceivable for the image data acquisition unit to be controlled by the processor 91 in order to acquire the image data.

The processor 91 is able to load program code from the memory 92 and execute it. When the processor 91 executes the program code, this has the effect that the processor carries out techniques such as are described, for example: applying a domain-specific model; applying a generic machine-learned foundation model; applying multiple models with varying complexity; training a model; performing an interactive annotation process; etc.

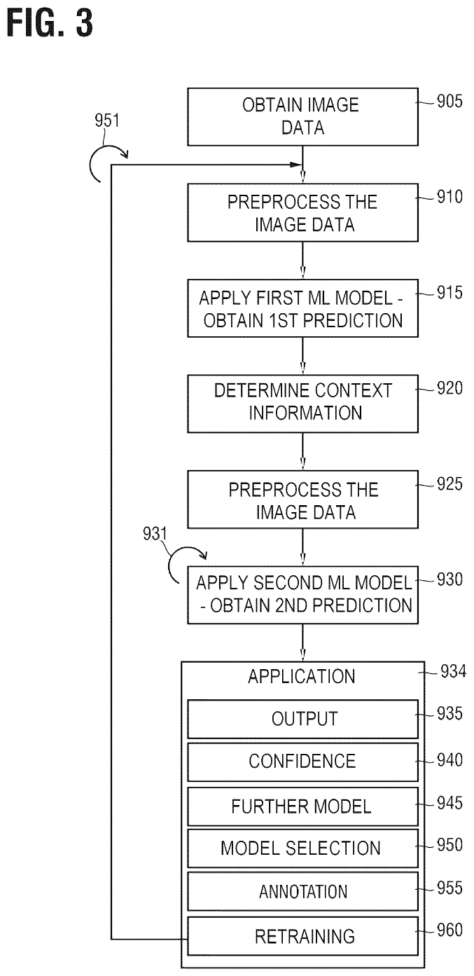

FIG. 3 is an exemplary method. The method from FIG. 3 is computer-implemented. By way of example, the method from FIG. 3 may be carried out by a processor when it executes program code from a memory. For example, the method from FIG. 3 may be carried out by the processor 91 from FIG. 2. The method from FIG. 3 concerns the processing of image data.

The image data are obtained in box 905. By way of example, these may be microscope image data. They may be 2D image data or 3D image data. The image data may be loaded in box 905 from an image data memory. The image data may be obtained in box 905 from an image data acquisition unit such as a microscope, for example.

The image data may then be preprocessed in optional box 910. The preprocessing of the image data in box 910 may for example comprise rescaling and/or normalizing the intensity and/or correcting aberrations. Other examples concern denoising and/or deconvolution.

Rescaling may include adjusting the image size such that the pixel dimensions of certain objects correspond to a desired standard size. This greatly simplifies the problem and thus reduces the required complexity of the model.

As an alternative or in addition to rescaling, other image properties may also be normalized, for example contrast and/or brightness, etc. If for example phase contrast is used as the imaging technique, microscope images often have low intensity contrast. It has been identified that this may impair the analysis in models.

Sometimes, image data may contain convolutions, for example when they have been obtained using magnetic resonance tomography or other imaging methods operating in the spatial frequency domain. In this case, deconvolution methods (also called image reconstruction) may be used to remove or at least reduce such convolution artifacts.

Noise may be caused by various factors such as camera quality, exposure or transmission errors. There are known algorithms that reduce such noise—often based on its statistical nature.

In box 915, a first model is applied to the (possibly preprocessed) image data. The first model is a domain-specific model. Corresponding aspects have been discussed above in connection with FIG. 1 and the model 231.

Applying the first model gives a first prediction for image features. By way of example, a localization of certain structures may be obtained as an example of the image features. By way of example, the corresponding localization information could be provided with class information. Example: “A cell nucleus is located at point (23, 45). Background is located at coordinate (89, 1011)”.

It should, as far as possible, have a low false-positive rate (that is to say the objects found by the model are actually real) and deliver results with high confidence. A high false-negative rate may possibly have to be accepted here (some objects are not found), but this may be advantageous in most cases. This is based on the following finding: The false-positive rate should be as low as possible so that the context information derived therefrom is not incorrect and the second model does not receive any incorrect “base points”. The absence (false-negative rate) of points is not problematic, however, since the second model is intended to supplement the completeness of the segmentation in any case.

Context information for the foundation model is determined in box 920. The context information is determined based on the first prediction from box 915. In one variant, the first prediction from box 915 may be adopted directly as context information. By way of example, the first prediction could be a point localization together with associated class information, as described in connection with FIG. 1. In such a case, the first prediction may be adopted directly as context information.

It has been identified that it may be helpful for the first prediction to be incomplete. By way of example, it may be helpful for corresponding localization information to provide an incomplete localization of certain structures in the image data. In some scenarios, it is possible for the first prediction to be inherently incomplete since a domain offset occurs (that is to say such image data with certain properties have not yet been seen up to now in the training of the first model).

As an alternative, however, it would also be conceivable for the first prediction to be modified, that is to say changed or amended.

The first prediction may be subsampled, for example using a random subsampling scheme. Example: The first model delivers, for each cell in the image, the coordinates of the associated cell nucleus. Entries may be drawn randomly from the list of all cell nuclei in order to obtain an incomplete version. This corresponds to artificially worsening the first prediction. In addition to a random subsampling scheme, it would also be possible to use a deterministic subsampling scheme that for example discards or retains a certain part of the first prediction depending on a confidence.

Subsampling is only one option for a modification, however. Other examples include applying noise (noising). For example, the coordinates of a point localization could have noise applied to them. For example, white noise or Gaussian smearing could be applied.

As an alternative or in addition to such an algorithmic modification of the first prediction in order to determine the context information, the first prediction may also be modified based on a user input received from a user interface. See in particular the human-machine interface 94 in FIG. 2.

In box 925, the image data may optionally be preprocessed before the image data are input into the second model. In particular, corresponding techniques, as discussed above in connection with box 910, may, as an alternative or in addition, also be applied in box 925. This means that the image data may be preprocessed before the image data are input into the first model in box 910 and/or the image data may be preprocessed before the image data are input into the second model in box 925. By way of example, it is possible for the image data in box 910 to be preprocessed differently than in box 925. To give one example: It would be conceivable, in box 110, for the image data to be rescaled, whereas the contrast is normalized in box 925.

The second model is then applied in box 930 in order to obtain a second prediction. The second prediction has the same semantic content as the first prediction from box 915 (both predictions localize cells, for example). However, the second prediction may have a higher quality. By way of example, the second prediction could be more accurate, have a higher degree of detail, have a higher resolution in the image space, and/or be more complete than the first prediction. Corresponding aspects in connection with the application of the second model have already been discussed in connection with FIG. 1: foundation model 241.

The prediction from box 930 then continues to be used in box 934. FIG. 3 shows some possible implementations for box 934 in the form of the boxes 935, 940, 945, 950, 955, 960. Individual boxes or combinations of these boxes may be implemented.

By way of example, it would be possible to output the prediction of the second model in box 935. For example, a semantic segmentation (see FIG. 1: second prediction 292) overlaid with the original image data (see FIG. 1: image data 211) could be output to a user via a screen. In such a variant, the original result from box 915 may thus be improved by way of the second model in box 930. If for example incomplete cell localization occurs using the domain-specific model in box 915, this incomplete cell localization may be supplemented by applying the foundation model in box 930. However, the degree of detail may also be increased. If for example the domain-specific model in box 915 delivers localization information in the form of center points of the cells, then the foundation model in box 925 may provide one or more instance segmentation masks for cells and background, or even different cell types. Such enhanced information may then be output to the user.

As an alternative or in addition, a confidence for the second prediction may be determined in box 940. This may be carried out based on a variation between multiple instances of the second prediction from box 930 (FIG. 3 illustrates that box 930 may be implemented in multiple iterations 931). In detail, for example, it would be possible to perform multiple iterations 931 of box 930, which each obtain different context information. By way of example, it has been described in connection with box 920 (box 920 may then also be implemented multiple times) that the context information may be ascertained, based on the first prediction from box 915, by modifying the first prediction. By way of example, different subscans could be performed. By way of example, different subsampling schemes could be used. A random subsampling scheme could also be implemented multiple times. The different iterations 931 of box 930 may thereby be provided with different context information. The confidence may then be computed from the individual results of the multiple iterations 931 as follows: for example, the variance/entropy of the individual results or another statistical deviation measure may be used to determine the confidence. It would also be possible, as an alternative or in addition, to determine a measure of matching from the difference between the individual results. The individual results could also be processed in a model in order thereby to determine the confidence. See for example German patent application 10 2021 100 444.

The variation between multiple instances of the second prediction may be determined in the image space in a resolved manner. This makes it possible to determine the confidence in the image space of the image data in a resolved manner. By way of example, it is possible to identify regions in the image data in which the confidence of the second prediction is comparatively low. In other scenarios, however, a global value for the confidence could also be output, that is to say averaging could be performed for example by changing the local properties of the second prediction for the different instances of the second prediction.

As described above, individual results for determining confidence may thus be obtained by repeatedly implementing the second model with different context information. Individual results of the different iterations 931 may also originate from different instances of the second model (for example different foundation models that have been trained with the same data but different initializations). Generally speaking, multiple instances of the second prediction for image features may thus be obtained by way of the second model. These multiple second instances may be obtained through different instances of the context information that have been modified in relation to one another and/or different instances of the first prediction for the image features from the first model (for example, the first model could be initialized with different random parameters; the first model could also have a random component, for example for sampling a latent feature vector, such that the first model is able to deliver different first predictions for the same input). It would also be possible to use different configurations of the second model, for example different training states, etc.

The confidence ascertained in box 940 may be output to a user, for example. The human-machine interface may be controlled accordingly for this purpose. It is also conceivable to use the confidence to assess the second model. By way of example, the confidence could be compared with a predefined threshold value, and further use of the second prediction of the second model could be prevented if the confidence falls below the predefined threshold value. Model selection may take place based on the ascertained confidence; see also box 950. By way of example, a suitable first model may be selected, by way of which context information allowing a prediction of the second model with high confidence is obtained. This thus means that the confidence of the prediction of the second model may be used as a measure of the suitability of the first model for creating context information for the second model.

In box 945, the prediction from box 930 could be used as input for a further foundation model. This means that the generated data of the foundation model may also be used for a further foundation model, namely for example (i) as training data to train a new foundation model and/or (ii) in an iterative process as context information (instead of the context information obtained from the domain-specific model).

Model selection may optionally take place in box 950. If multiple models are able to be selected for a task (for example a “model zoo”), the most suitable model may be determined automatically. Either the foundation model and/or the domain-specific model may be selected here. The model with the greatest confidence could be selected.

By way of example, the suitability of the domain-specific model for generating the context information may be inferred based on the confidence of the prediction of the foundation model. The suitable domain-specific model may therefore be selected based on the confidence of the prediction of the foundation model.

In box 955, an annotation process may optionally be set based on the second prediction from box 930. The annotation process is used to generate ground truths for retraining the first model in box 960. This thus means that, in other words, in the course of the annotation process, a ground truth for training data is generated through user interaction; this generation of the ground truth may be greatly accelerated, compared to a purely manual annotation, by setting the annotation process based on the second prediction from box 930. By way of example, a localization and/or classification of the second prediction could be output to a user in a manner overlaid with the image data. The user may then confirm or edit the second prediction. For example, the task is made much simpler for the user by virtue of the user not having to manually perform cell segmentation in a microscope image, but rather being able to check and locally change the segmentation provided by the second model. Depending on how the segmentation mask is displayed, there are various options for enabling simple, accurate and rapid user interaction. By way of example, the user may modify a segmentation mask by displacing splines of the segmentation mask. The user may modify the annotations by displacing points of a polygon. In the case of a pixel mask, a “brush tool” may be used to either add (“paint in”) or remove (“erase”) parts of the masks.

The user is thus able to change the second prediction directly in order to adapt the ground truth. In addition to such direct manipulation of the second prediction, the user may also change the second prediction indirectly. A corresponding example is explained below.

In the course of the user-interactive annotation process, box 920 could also be implemented multiple times (see iterations 921). In particular, it would be conceivable for the user-interactive annotation process to comprise modifying the context information based on a user input and accordingly outputting the influence of the modification of the context information on the second prediction of the second model to the user. By way of example, the user may displace a specific point localization that has been predicted by the first model and then check how this change of the context information influences the second prediction of the second model. The user could delete or add individual point localizations and check in each case how this change of the context information influences the prediction of the second model.

It is possible to set the user-interactive annotation process not only on the basis of the second prediction, but, as an alternative or in addition, also on the basis of a confidence of the second prediction (see box 940). By way of example, in the course of the user-interactive annotation process, it would be possible to output those parts of the second prediction that have a lower confidence (cf. box 940) with higher priority (for example before other parts with lower priority or particularly emphasized, etc.). By way of example, if the confidence is determined in the image space in a resolved manner, then it would be conceivable to graphically highlight the regions in the image space that are associated with a lower confidence.

In summary, box 955 may enable an interactive annotation process that may be used to generate segmentation masks, instance segmentation masks, point annotations and/or bounding box annotations for microscopy data for model training. The context information for the second model is provided here only by the user, only by the first model (in an earlier training state), or by both, and the prediction of the second model then serves as ground truth for training data for retraining the first model. The annotation process may be interactive in that the second model, or at least part of the second model, is inferred multiple times during the annotation process (multiple iterations 931 in one iteration 951) in order to indicate to the user which output generates the current context information.

By way of example, it has been explained above that the second model does not obtain the context information at the input layer (where the image data are provided), but at a point along the data processing pipeline that is arranged closer to the output layer, at a distance from the input layer. In such a case, in order to determine the influence of the modification of the context information on the second prediction of the second model, in each case only that part of the second model that has a dependency on the context information may be inferred again. In other words, the first part of the second model (see FIG. 1: 241-1) may thus be inferred once; and then only the second part of the second model (see FIG. 1: 241-2), which has a dependency on the context information, may be inferred again. This saves significant computing resources.

By manipulating the context information, the user is able to remove and add annotations until a satisfactory result is achieved. The user-interactive annotation process may in this case comprise modifying the context information in box 920 based on a user input (a corresponding user input for the modification has already been described in connection with box 920) and outputting the influence of this user-induced modification on the second prediction in box 930. This means that the user is able for example to change, add or delete individual elements of the second prediction, for example specific point localizations in cells or in the background. The user may then be shown how the prediction of the second model changes due to such a change. The second model may be made available to a user once; the user may then use this second model to train one or more domain-specific models themselves by way of an interactive annotation process for generating training data. In the annotation process, an active learning functionality may then also be implemented, inter alia, showing the user regions that are worth annotating. A domain-specific model (and also the optional foundation model) may thereby be improved continuously over time.

Different metrics may be used as a measure of the regions that are “worth” annotating. One exemplary metric is confidence (see box 940). Further metrics are given below in Table 1.

| | |
|---|---|
| Balance between | The selection of the regions to be annotated is |
| exploration and use | seen as a trade-off between exploration and use in |
| | the data space. |
| Expected model | Annotation of those regions that would change the |
| change | second model to the greatest extent. |
| Expected error | Labeling of the data points that would reduce the |
| reduction | generalization error of the second model to the |
| | greatest extent. |
| Exponentiated | A sequential algorithm that is able to improve any |
| gradient exploration | active learning process through optimum random |
| | exploration. |
| Random sample | A region to be annotated is selected randomly. |
| Entropy sample | The region to be annotated associated with the |
| | highest entropy is considered to be the least |
| | reliable |
| Limit sample | In a semantic segmentation with class assignment: |
| | The range with the smallest difference between the |
| | two highest class probabilities is selected. |
| Request by | Various auxiliary models are trained and vote on |
| committee | the result. |
| Variance reduction | Annotation of the region that would minimize the |
| | output variance. |
| Conformal | Prediction that a new region will have a similar |
| prediction | label to the already annotated regions |
| Mismatch-first | Focuses on incorrectly annotated regions and aims |
| farthest-traversal | to optimize the diversity of the selected data |

Table 1: Various strategies allowing the user to manipulate the first prediction by way of an active learning process. Based on such criteria, part of the prediction of the first model may be selected and presented to the user; the user may then modify or manipulate the corresponding part of the first prediction in order thereby to create changed context information. Box 955 may also include performing the annotation process. When the annotation process is complete, training data are available. These training data may then be used to retrain the first model in box 960.

However, it is not necessary in all variants to use a user-interactive annotation process. By way of example, it is conceivable for the retraining in box 960 to be based on training data containing the second (unchanged) prediction from box 930 as ground truth. Such techniques are based on the assumption that the second model is much more complex and powerful than the first model and generalizes to a wide variety of domains. However, it is possible to transfer knowledge for a particular task to the first model. This approach is similar to what is known as “knowledge distillation” (a small, real-time capable model learns from a large, complex but computationally intensive model), with the difference that the large model (here the second model from box 930) is guided by the first model from box 915 through the provision of context information (what is known as “prompting”). The process of generating the ground truth may also take place iteratively.

The process of generating ground truth and retraining (box 955 with box 960) may also take place iteratively here: In iteration n, the first model generates the context information and the second model delivers outputs, which, together with the input images, form an instance of training data. This instance of the training data is then used to retrain the first model (retraining). The retrained first model is then implemented again in order to generate new context information in iteration n+1; the second model is then implemented again with the new context information in iteration n+1. This process may be repeated multiple times (see iteration 951 in FIG. 3).

In one special case (either when the first model is still untrained or does not exist at all, for example in the first iteration), the context information in box 920 comes from a user. This may generally be seen as an “assisted annotation process” in which the user only needs to annotate a fraction of the data compared to a conventional annotation tool, and the creation of a complete dataset is assisted to a great extent by the second model (when creating the target data).

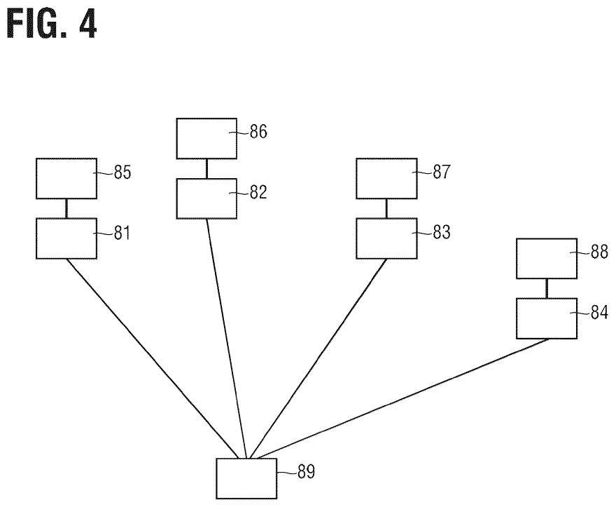

FIG. 4 schematically shows a use scenario for a foundation model according to various examples. The figure shows a central server 89 that is communication-connected to a multiplicity of data processing devices 81-84. By way of example, the server 89 may communicate with the data processing devices 81-84 via the Internet. The server 89 may be configured as a cloud server.

Each of the data processing devices 81-84 may for example be configured in accordance with the data processing device 90 (see FIG. 2).

The server 89 may store a central foundation model, for example the foundation model 241 from FIG. 1, and transfer it to the data processing devices 81-84. The central storage of the foundation model 241 enables central training of the foundation model.

On the basis of these copies of the foundation model, the various data processing devices 81-84 may then each locally generate and train multiple domain-specific models. For this purpose, the data processing devices 81-84 are coupled to an associated image acquisition unit 85-88, wherein the image acquisition device in 85-86 is configured to acquire image data. By way of example, the image acquisition units 85-88 may be microscopes.

Typically, different users use the different data processing devices 81-84 and image acquisition units 85-88. The different users also have different requirements in terms of the corresponding domain-specific models. By way of example, one user might want cell instance segmentation on the basis of image data that were recorded with a specific color filter for specific cell types. Another user, on the other hand, might want semantic cell segmentation using a different filter or no filter at all or another imaging technique (for example light sheet microscopy instead of fluorescence microscopy). For these reasons, it is necessary to create and train different domain-specific models that are adapted to the respective requirements of the different users. This process is assisted and simplified by the central foundation model.

In summary, a description has been given above of techniques as to how an upstream domain-specific model with a low degree of complexity is able to be used to generate context information for a generic foundation model having a high degree of complexity. Both the domain-specific model and the foundation model process image data. This in particular makes it possible to improve and accelerate the generation of ground truths for training data for retraining the domain-specific model.

It goes without saying that the features of the embodiments and aspects of the invention described above may be combined with one another. In particular, the features may be used not only in the combinations described but also in other combinations or on their own, without departing from the scope of the invention.

By way of example, a description has been given above of various aspects in connection with a domain-specific machine-learned model having a U-net architecture. However, the specific architecture of the domain-specific machine-learned model is not crucial for the techniques described herein. The techniques described herein may work with different architectures that are already known in principle to a person skilled in the art.

As a further example, a description has been given above of localizations of structures in connection with point localization and instance segmentation. However, other forms of localization information, for example bounding box localization, are also conceivable.

1. A computer-implemented method for processing image data, wherein the method comprises:
obtaining the image data,
processing the image data in a domain-specific machine-learned model in order to obtain a first prediction for image features in the image data, wherein the first prediction comprises a first localization of structures in the image data,
determining context information for a generic machine-learned foundation model based on the first prediction for the image features,
based on the context information, processing the image data in the generic machine-learned foundation model in order to obtain a second prediction for the image features, wherein the second prediction comprises a second localization of the structures in the image data.

2. The computer-implemented method as claimed in claim 1, wherein the method furthermore comprises:
performing retraining of the domain-specific machine-learned model based on training data that comprise a ground truth determined based on the second prediction.

3. The computer-implemented method as claimed in claim 1, wherein the method furthermore comprises:
based on the second prediction: setting a user-interactive annotation process that is used to generate ground truths for retraining the domain-specific machine-learned model.

4. The computer-implemented method as claimed in claim 3,
wherein the user-interactive annotation process comprises modifying the context information based on a user input and accordingly outputting the influence of the modification of the context information on the second prediction to the user.

5. The computer-implemented method as claimed in claim 4, wherein, in order to determine the influence of the modification of the context information on the second prediction, only that part of the generic machine-learned foundation model that has a dependency on the context information is in each case inferred again.

6. The computer-implemented method as claimed in claim 4,
wherein setting the user-interactive annotation process comprises:
based on an active learning process: selecting part of the first prediction in order to modify the context information based on the user input.

7. The computer-implemented method as claimed in claim 1,
wherein the first localization has a first accuracy,
wherein the second localization has a second accuracy,
wherein the second accuracy is greater than the first accuracy.

8. The computer-implemented method as claimed in claim 1,
wherein the first localization has a first image space density,
wherein the second localization has a second image space density,
wherein the second image space density is greater than the first image space density.

9. The computer-implemented method as claimed in claim 1,
wherein the first localization has a first localization degree of detail,
wherein the second localization has a second localization degree of detail,
wherein the second localization degree of detail is greater than the first localization degree of detail.

10. The computer-implemented method as claimed in claim 1,
wherein the first prediction and/or the second prediction furthermore comprises classifying the structures in the image data.

11. The computer-implemented method as claimed in claim 10,
wherein the first prediction comprises a point localization of structures and associated class assignments to multiple classes,
wherein the second prediction comprises multiple result masks of a semantic segmentation or an instance segmentation of the structures, wherein the multiple result masks correspond to the multiple classes.

12. The computer-implemented method as claimed in claim 1, wherein determining the context information comprises:
modifying the first prediction.

13. The computer-implemented method as claimed in claim 12, wherein modifying the first prediction comprises subsampling the first prediction, optionally random subsampling.

14. The computer-implemented method as claimed in claim 12,
wherein modifying the first prediction comprises applying noise to the first prediction.

15. The computer-implemented method as claimed in claim 12,
wherein the first prediction is modified based on a user input received from a user interface.

16. The computer-implemented method as claimed in claim 15, wherein the method furthermore comprises:
outputting part of the first prediction to the user, said part being selected based on an active learning process, and
receiving the user input, which concerns a modification of the part of the first prediction.

17. The computer-implemented method as claimed in claim 1,
wherein multiple instances of the second prediction for the image features are obtained by way of the generic machine-learned foundation model,
wherein the multiple instances of the second prediction correspond to different instances of the context information that have been modified in relation to one another and/or different instances of the first prediction for the image features and/or different configurations of the machine-learned foundation model.

18. The computer-implemented method as claimed in claim 1, wherein the method furthermore comprises:
determining a confidence of the second prediction based on a variation between multiple instances of the second prediction.

19. The computer-implemented method as claimed in claim 18,
wherein the confidence is determined in the image space of the image data in a resolved manner,
wherein the method furthermore comprises:
based on the confidence of the second prediction: setting a user-interactive annotation process that is used to generate ground truths for retraining the domain-specific machine-learned model.

20. The computer-implemented method as claimed in claim 1, wherein the method furthermore comprises:
preprocessing the image data before processing in the domain-specific machine-learned model and/or before processing in the generic machine-learned foundation model.

21. The computer-implemented method as claimed in claim 20,
wherein the preprocessing comprises one or more of the following operations: rescaling; intensity normalization; aberration correction; denoising; and deconvolution.

22. The computer-implemented method as claimed in claim 20,
wherein the image data are preprocessed differently before processing in the domain-specific machine-learned model than before processing in the generic machine-learned foundation model.

23. A data processing device having a processor and a memory, wherein the processor is configured to load program code from the memory and execute it, wherein the processor implements a method as claimed in claim 1, when it executes the program code.
